(19) United States
(12) Patent Application Publication
(10) Pub. No.: US 2005/0104040 A1
(43) Pub. Date: May 19, 2005

(54) Phosphors formulation for fluorescent lamps

(76) Inventor: Fred M. Mendelsohn, Tampa, FL (US)

Correspondence Address: Arthur W. Fisher, III, Suite 316, 5553 West Waters Avenue, Tampa, FL, 33634, US

(21) Appl. No.: 10/731,798

(22) Filed: Dec. 9, 2003

Related U.S. Application Data
(60) Provisional application No. 60/520,217, filed on Nov. 14, 2003.

(51) Int. Cl. C09K 11/08

(52) U.S. Cl. 252/301.4 R

(57) ABSTRACT

A combination of phosphors formulated to coat the inside of a fluorescent lamp to emit light having a spectral distribution to enhance effective pupil lumen comprising effective amounts of strontium boride, yttrium oxide, barium yttrium, europium, terbium, barium borate and calcium having a peak luminescence in the scotopic range.

### CROSS REFERENCE APPLICATION

This is a non-provisional patent application of provisional patent application Ser. No. 60/520217, filed Nov. 14, 2003.

### BACKGROUND OF THE INVENTION

1. Field of the Invention

A combination of phosphors formulated to coat the inside of a fluorescent lamp.

2. Description of the Prior Art

Historically, the output of artificial lighting has been measured for photopic content of the light while generally ignoring the effect of the scotopic content.

The process of selecting and combining phosphors for fluorescent lamps is not new or unique. Unfortunately, however, relatively recent scientific knowledge relating to visual acuity and fluorescent technology has not been effectively applied commercially.

Research has demonstrated that by fine tuning the light spectrum, light levels can be reduced without compromising visual acuity and color response. Due to the physiological aspects of the eye, it is possible to decrease light levels without reducing performance by controlling the spectral distribution of artificial lighting. As a result energy savings achieved by relative efficacy of light production (lumens) of spectrally modified lamps.

In particular, the retina of the eye has both rod and cone receptors. The rods operate at low light levels, the cones operate at high light levels, and both operate over a range at intermediate light levels. Rods (night vision) do not provide color response or high visual acuity. On the other hand, cones provide color vision and the acuity necessary for reading and seeing small detail.

Photopic lumens are based on cone sensitivity, while scopotic lumens are based on rod sensitivity. In photopic conditions, wavelengths near 550 nanometers appear to be brighter than those near 500 nanometers. The reverse is true in scotopic conditions where wavelengths near 510 nanometers are brighter than those near 550 nanometers.

For example during the day, yellow objects appear lighter, but as the sun goes down and the scotopic comes into play green objects appear lighter. At dusk, illumination is low enough for the scotopic effect to operate, but still high enough for the photopic to also operate.

Since cones and rods both contribute to visual acuity S/P (scotopic/photopic ratios) are a useful tool in analyzing the effectiveness of a light source on visual acuity.

Examples of past efforts to improve the source of indoor lighting are found in numerous patents.

U.S. Pat. No. 3,670,193 describes electric lamps having spectral radiation characteristics approximating natural daylight with a controlled amount of energy in the near and middle ultraviolet ranges which also produce light of sufficient intensity and proper color to make them usable as general illuminants.

U.S. Pat. No. 4,891,550 teaches a full spectrum fluorescent lamp having a phosphor coating for producing visible light having a high color rendering index and balanced amounts of ultraviolet energy at the same correlated color temperature in which the coating is formed of two groups of phosphors.

U.S. Pat. No. 4,174,294 shows a fluorescent material comprising an alkaline earth metal boron phosphate activated by a divalent europium compound.

U.S. Pat. No. 5,122,710 describes a phosphor blend for a fluorescent lamp having four rare earth phosphors each of which emits a narrow band of visible light energy in the visible spectrum. The color of the light produced by three of the phosphors is red, blue and green. The fourth phosphor producing light in the blue-green range improves the color rendering index of the visible light output without seriously affecting the lumen output as compared to a blend in which only the red-blue-green phosphors are used. A fifth rare earth narrow band phosphor capable of producing energy in the ultraviolet A range can be added to the blend when it is desired to simulate various phases of natural daylight. The band of ultraviolet range energy produced can be smoothed by adding to the blend another phosphor capable of producing energy in the ultraviolet range.

Regardless of these efforts there remains a need to develop a combination of phosphors for use in a fluorescent lamp to emit a wavelength of light optimized for human visual acuity which is optimized at about 510 nanometers. At this wavelength, the amount of scotopic lumens that affects the rod receptors in the eye is maximized. The light emitted from this phosphor combination causes the pupils of the eye to contract without the presence of painful glare and an overabundance of bright light, thereby enabling the human eye to see with greater clarity, efficiency and better focus. This optimal efficiency of the human eye generated by the high scoptopic lumens, is produced in an environment of lower photopic lumens, which normally would be construed as lower ambient light, thereby utilizing less electrical energy than comparable lighting sources.

### SUMMARY OF THE INVENTION

The present invention relates to a composition of phosphors formulated to coat the inside of a fluorescent lamp to enhance effective pupil lumens for improved human visual acuity.

The selection, combination and utilization of certain rare earth phosphors can be formulated for use in a fluorescent lamp to peak length of about 510 nanometers. The light emitted from such a phosphor combination causes the pupils of the eye to contract without the presence of painful glare and an over abundance of bright light, enabling the human eye to see with greater clarity, efficiency and better focus. This optimal efficiency of the human eye generated by the high scoptopic lumens is produced in an environment of lower photopic lumens, which normally would be construed as lower ambient light, thereby utilizing less electrical energy than comparable lighting sources.

The formulation of phosphor combination of the present invention comprises seven phosphors, which when emulsified and used to coat the inside of a fluorescent lamp, will emit light in a wavelength from about 505 nanometers to about 515 nanometers which has been demonstrated to be the optimal wavelength for human visual acuity. The seven phosphors are strontium boride, yttrium oxide, barium yttrium oxide, europium, terbium, barium borate and calcium.

This combination of phosphors results in a power distribution including a major peak, a minor peak separated by a trough.

The process of emulsifying the phosphors comprises of creating a binder with water and polyethylene chloride with an adhesive slurry. After the binder has blended, phosphors are added to the binder. The pH is elevated, and the mixture is blended. At completion of the blending the mixture is filtered and is suitable for coating fluorescent lamps.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a graph showing the power distribution of the present invention.

FIG. 2 is a tabular representation of various lamps and operating characteristics.

Similar reference characters refer to similar parts throughout the several views of the drawings.

### DETAILED DESCRIPTION OF THE PREFERRED EMBODIMENT

The present invention relates to a composition of phosphors formulated to coat the inside of a fluorescent lamp to enhance effective pupil lumens for improved human visual acuity. Studies have determined that human visual acuity is a function of both scotopic and photopic lumens. It has been observed the visual acuity is optimized at a light wavelength of about 510 nanometers. At this wavelength, the amount of scotopic lumens which affects the rod receptors in the eye is maximized.

The selection, combination and utilization of certain rare earth phosphors can be formulated for use in a fluorescent lamp to peak length of about 510 nanometers. The light emitted from such a phosphor combination causes the pupils of the eye to contract without the presence of painful glare and an over abundance of bright light, enabling the human eye to see with greater clarity, efficiency and better focus. This optimal efficiency of the human eye generated by the high scoptopic lumens is produced in an environment of lower photopic lumens, which normally would be construed as lower ambient light, thereby utilizing less electrical energy than comparable lighting sources.

The selecting and combining of various phosphors for use in fluorescent is not new or unique. Unfortunately, the combination of the body of scientific knowledge surrounding visual acuity with fluorescent technology, to produce a light emitter that helps people to see as well as the human eye can see, has not been done commercially. Heretofore, the proper combination of phosphors that could yield the result of light emitted at the optimum wavelength of about 510 has been unknown.

The formulation of phosphor combination of the present invention comprises seven phosphors, which when emulsified and used to coat the inside of a fluorescent lamp, will emit light in a wavelength from about 505 nanometers to about 515 nanometers which has been demonstrated to be the optimal wavelength for human visual acuity. The seven phosphors are strontium boride,. yttrium oxide, barium yttrium oxide, europium, terbium, barium borate and calcium in relative proportions as shown in Table 1 below.

TABLE 1

| | | | Percentage |
|---|---|---|---|
| Compound | Formula | Element Color(s) | by Weight |
| Strontium Boride | SrB₆ | Red/Green | 46% |
| Yttrium Oxide | Y₂O₃ | Red | 24% |
| Barium Yttrium Oxide | Ba₄Y₂O₇ | Green/Red | 24% |
| Europium | Eu | Red | 2% |
| Terbium | Tb | Green | 2% |
| Barium Borate | Ba₄B₂O₇ | Green | 1% |
| Calcium | Ca | Yellow | 1% |

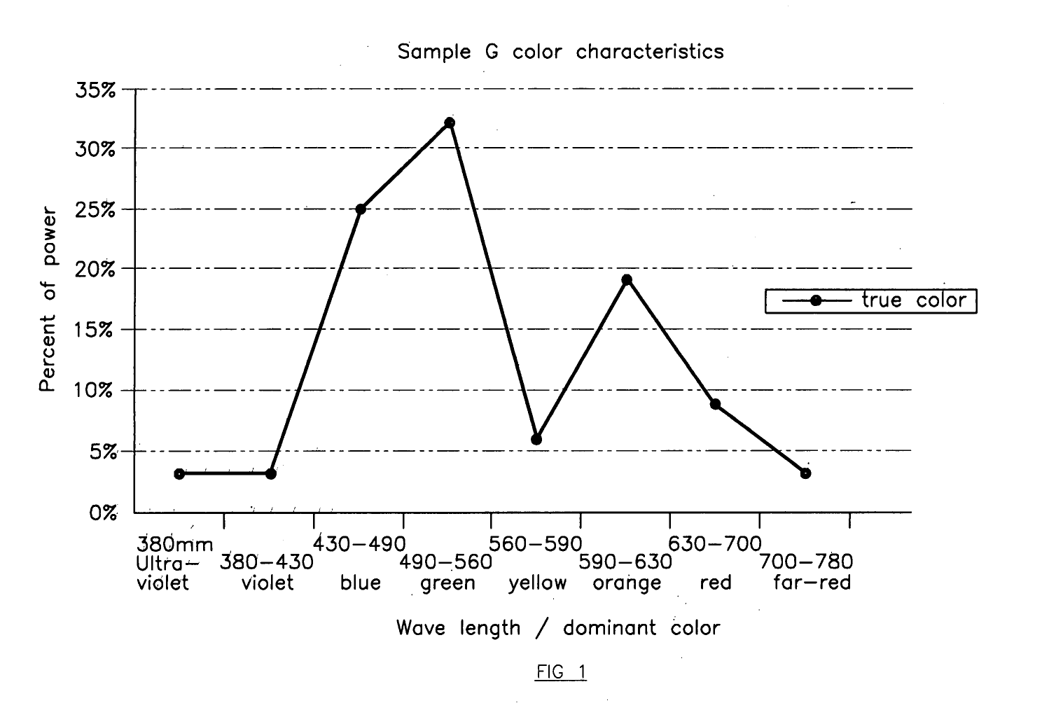

As shown in FIG. 1, this combination of phosphors results in a power distribution having a major peak of at least 30 percent of the total power at about 510 nanometers, a minor peak of at least 15 percent of the total power at about 610 nanometers and a trough of less than 10 percent of the total power at about 575 nanometers. As depicted, the percentage of power at the major peak is at least 5 times the percentage of power at the trough and at least 1.5 times the percentage of power at the minor peak.

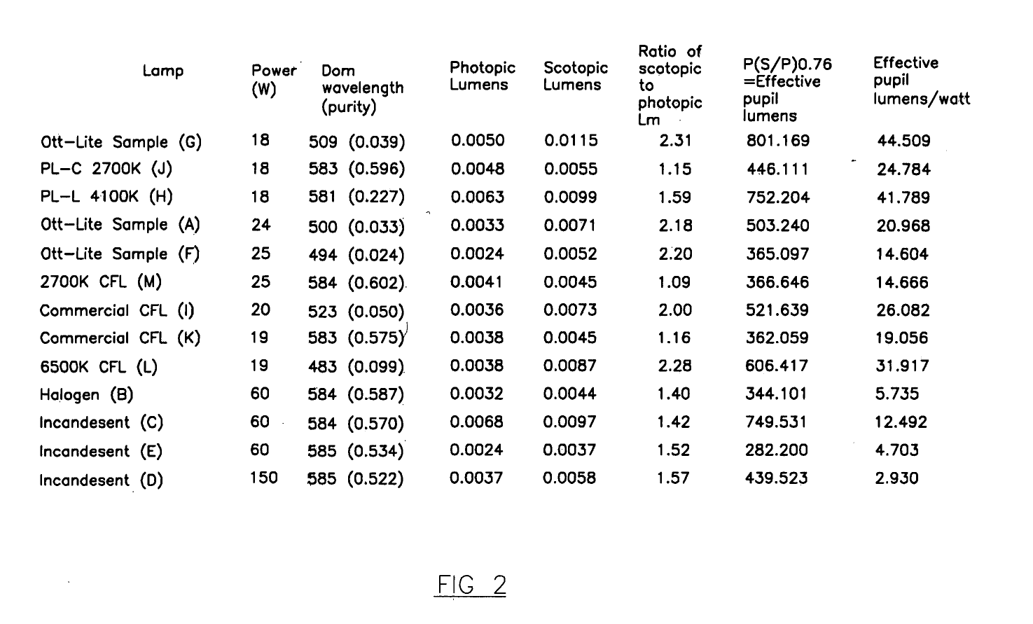

FIG. 2 illustrates the relative effectiveness of the present invention referred to as Ott-Lite Sample (9) compared to other lamps. As shown at about 510 nanometers or optimum wavelength, the photopic lumens and scotopic lumens are about 0.0050 and about 0.0115 respectively with a scotopic lumen to photopic lumen ratio about 2.31. The resulting effective pupil lumens are about 801.169 and the effective pupil lumens per watt are about 44.509.

The process of emulsifying the phosphors comprises of creating a binder with de-ionized water and polyethylene chloride in a ratio of 1.5 kilograms of polyethylene chloride to 100 liters of water and 3 kilograms of adhesive slurry. This is mixed at 100 revolutions per minute for three hours. After the binder has blended, 30 kilograms of phosphors that have been previously measured in the above proportions are added to the binder. A 15% ammonia water solution is added until the pH is elevated to 9, and the mixture is blended for three hours at 100 rpm. At completion of the blending the mixture is filtered through a #200 stainless steel mesh net and is suitable for coating fluorescent lamps.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

1. A combination of phosphors formulated to coat the inside of a fluorescent lamp to emit light having a spectral distribution to enhance effective pupil lumens comprising effective amounts of two or more of the following:
strontium boride, yttrium oxide, barium yttrium, europium, terbium, barium borate and calcium having a peak luminescence in the scotopic range.

2. The combination of phosphors of claim 1 wherein the power distribution includes a major peak and a minor peak separated by a trough.

3. The combination of phosphors of claim 2 wherein the percentage of power at the major peak is at least 5 times the percentage of power at the trough.

4. The combination of phosphors of claim 3 wherein the percentage of power at the major peak is at least 1.5 times greater than percentage of power at the minor peak.

5. The combination of phosphors of claim 2 wherein the percentage of power at the major peak is at least 1.5 times greater than percentage of power at the minor peak.

6. The combination of phosphors of claim 1 wherein the dominant wave length is from about 505 to about 515 nanometers.

7. The combination of phosphors of claim 1 wherein the scotopic lumen to the photopic lumen ratio is at least 2.25.

8. The combination of phosphors of claim 7 wherein the effective pupil lumens is at least 2.25^{0.78} times the photopic lumens measured in the lamp output.

9. The combination of phosphors of claim 8 wherein the effective pupil lumens per watt is at least about 40.

10. The combination of phosphors of claim 7 wherein the effective pupil lumens per watt is at least about 40.

11. The combination of phosphors of claim 1 wherein the effective pupil lumens is at least 2.25^{0.78} times the photopic lumens measured in the lamp output.

12. The combination of phosphors of claim 11 wherein the effective pupil lumens per watt is at least about 40.

13. The combination of phosphors of claim 1 wherein the effective pupil lumens per watt is at least about 40.

14. The combination of phosphors of claim 1 wherein the scotopic lumen to the photopic lumen ratio is about 2.25.

15. The combination of phosphors of claim 14 wherein the effective pupil lumens is 2.3^{0.78} times the photopic lumens measured in the lamp output 0.

16. The combination of phosphors of claim 15 where the effective pupil lumens per watt is about 45.

17. The combination of phosphors of claim 14 wherein the effective pupil lumens is 2.3^{0.78} times the photopic lumens measured in the lamp output.

18. The combination of phosphors of claim 1 wherein the effective pupil lumens is 2.3^{0.78} times the photopic lumens measured in the lamp output.

19. The combination of phosphors of claim 18 wherein the effective pupil lumens per watt is about 45.

20. The combination of phosphors of claim 1 wherein the effective pupil lumens per watt is about 45.

21. The combination of phosphors of claim 1 wherein the percentages by weight of the combination of phosphors are about 46 percent strontium boride, about 24 percent each of yttrium oxide and barium yttrium oxide, about 2 percent each of europium and terbium, and about 1 percent each of barium borate and calcium.

22. The combination of phosphors of claim 1 wherein the percentages by weight of the combination of phosphors are at least about 40 percent strontium boride, at least about 20 percent each of yttrium oxide and barium yttrium oxide, at least about 2 percent of europium and terbium, and at least about 1 percent of barium borate and calcium.

23. The combination of phosphors of claim 2 wherein the major peak is between about 540 and about 550 nanometers.

24. The combination of phosphors of claim 23 wherein the minor peak is between about 480 and about 500 nanometers.

25. The combination of phosphors of claim 24 wherein the trough is between about 560 and about 605 nanometers.

26. The combination of phosphors of claim 2 wherein the minor peak is between about 480 and about 500 nanometers.

27. The combination of phosphors of claim 26 wherein the trough is between about 560 and about 605 nanometers.

28. The combination of phosphors of claim 2 wherein the trough is between about 560 and about 605 nanometers.
